(19) United States
(12) Patent Application Publication
(10) Pub. No.: US 2019/0374962 A1
(43) Pub. Date: Dec. 12, 2019

(54) ELECTROSTATIC SPRAYING APPARATUS AND ELECTROSTATIC SPRAYING METHOD

(71) Applicant: ANEST IWATA Corporation, Kanagawa (JP)

(72) Inventors: Kazuaki SATO, Kanagawa (JP); Shoji KAKIZAKI, Kanagawa (JP)

(21) Appl. No.: 16/463,535

(22) PCT Filed: Oct. 31, 2017
(86) PCT No.: PCT/JP2017/039265

§ 371 Date: May 23, 2019

(30) Foreign Application Priority Data
Nov. 28, 2016 (JP) 2016-229861

(51) Int. Cl. B05B 5/025; B05B 5/08

(52) U.S. Cl. CPC B05B 5/025; B05D 1/04; B05B 5/08

(57) ABSTRACT

An electrostatic spraying apparatus according to an embodiment of the present invention is an electrostatic spraying apparatus that releases a liquid from a nozzle of a liquid sprayer in a charged state by an electrostatic force generated by application of a voltage and sprays the liquid to an object to be coated, in which the liquid sprayer includes a head having a nozzle group that includes a plurality of nozzles, and an external electrode disposed on an outer side of the nozzle group.

### TECHNICAL FIELD

The present invention relates to an electrostatic spraying apparatus and an electrostatic spraying method.

### BACKGROUND ART

Patent Literature 1 discloses an electrostatic nozzle apparatus (electrostatic spraying apparatus) which has a plurality of nozzles, charges a liquid of each nozzle by an electrostatic force generated by applying a voltage, and sprays the liquid by the electrostatic force.

Further, Patent Literature 1 discloses that the electrostatic spraying apparatus is used as a device that generates charged mist used in an air purifier by using water as the liquid.

### CITATION LIST

### Patent Literature

Patent Literature 1: JP 2008-516766 A

### SUMMARY OF INVENTION

### Technical Problem

Incidentally, Patent Literature 1 discloses a device that changes an applied voltage by a plurality of nozzles disposed in an annular shape on an outer side and a plurality of nozzles disposed in an annular shape on an inner side in order to obtain uniform spraying, or a device that causes a plurality of nozzles disposed in an annular shape on an inner side to protrude more than a plurality of nozzles disposed in an annular shape on an outer side in order to obtain uniform spraying.

From this point of view, uniformity of spraying is considered to be a problem when a plurality of nozzles is present on the inner side and the outer side. In a case in which there is only one layer of an annular part in which a plurality of nozzles is disposed, that is, in a case in which the plurality of nozzles disposed in the annular shape on the inner side is not present, it is expected that uniform spraying can be performed without any particular problem. However, even in a case in which there is only one layer of the annular part in which the plurality of nozzles is disposed, when a spray condition of each nozzle is observed, a moment of unstable spray is discovered to occasionally appear.

Even in the case of unstable spray that occasionally appears, there may be no problem in an application such as an air purifier in which it is sufficient to generate charged mist having a sufficiently small particle size.

However, in the case of applying a liquid such as paint to an object to be coated, when the moment of unstable spray appears, there is concern that uneven coating is caused. It is desirable that more stable spraying can be performed.

The present invention has been made in view of such circumstances, and an object of the present invention is to provide an electrostatic spraying apparatus and an electrostatic spraying method for improving stability of a spray condition of a liquid such as a paint, in an electrostatic spraying apparatus having a plurality of nozzles for spraying a liquid such as paint to an object to be coated. In addition, an object of the present invention is to provide an electrostatic spraying apparatus and an electrostatic spraying method for improving stability of a spray condition of a liquid such as a paint sprayed from each nozzle, in an electrostatic spraying apparatus having a plurality of nozzles for spraying a liquid such as paint to an object to be coated.

### Solution to Problem

The present invention is comprehended by configurations below to achieve the objects.

An electrostatic spraying apparatus according to an aspect of the present invention is an electrostatic spraying apparatus that releases a liquid from a nozzle of a liquid sprayer in a charged state by an electrostatic force generated by application of a voltage and sprays the liquid to an object to be coated, in which the liquid sprayer includes a head having a nozzle group that includes a plurality of nozzles, and an external electrode disposed on an outer side of the nozzle group, the same voltage as a voltage applied to the nozzles being applied to the external electrode.

An electrostatic spraying method according to an aspect of the present invention is an electrostatic spraying method of releasing a liquid from a nozzle of a liquid sprayer in a charged state by an electrostatic force generated by application of a voltage and spraying the liquid to an object to be coated, the electrostatic spraying method including disposing an external electrode on an outer side of a nozzle group including a plurality of nozzles to apply the same voltage as a voltage applied to the nozzle to the external electrode.

### BRIEF DESCRIPTION OF DRAWINGS

FIG. 1 is a side view of an electrostatic spraying apparatus of an embodiment according to the present invention.

FIG. 2 is a perspective view of a liquid sprayer of the embodiment according to the present invention.

FIG. 3 is a cross-sectional view passing through a center of the liquid sprayer of the embodiment according to the present invention.

FIG. 4A is a view illustrating a state in which an external electrode of the embodiment according to the present invention is removed and is an enlarged view of a portion corresponding to a dotted frame portion A of FIG. 1.

FIG. 4B is a view illustrating the state in which the external electrode of the embodiment according to the present invention is removed and is a photograph showing that a liquid is being sprayed.

FIG. 5A is a view illustrating a state in which the external electrode of the embodiment according to the present invention is attached and is an enlarged view of the portion corresponding to the dotted frame portion A of FIG. 1.

FIG. 5B is a view illustrating the state in which the external electrode of the embodiment according to the present invention is attached and is a photograph showing that the liquid is being sprayed.

FIG. 6A is a view for description of arrangement of the external electrode of the embodiment according to the present invention and is a view illustrating a state in which the external electrode is not provided.

FIG. 6B is a view for description of the arrangement of the external electrode of the embodiment according to the present invention and is a view illustrating a state in which the external electrode is provided.

FIG. 7 is a perspective view illustrating a modification of a head of the embodiment according to the present invention.

### DESCRIPTION OF EMBODIMENTS

Hereinafter, a detailed description will be given of a mode (hereinafter embodiment) for implementing the present invention with reference to accompanying drawings.

The same reference symbol is assigned to the same element throughout the whole description of the embodiment.

In addition, unless otherwise noted, expressions such as “distal (end)”, “front (side)”, etc. indicate a spray direction side of a liquid in each member, etc., and expressions such as “proximal (end)”, “back (side)”, etc. indicate an opposite side from the spray direction side of the liquid in each member, etc.

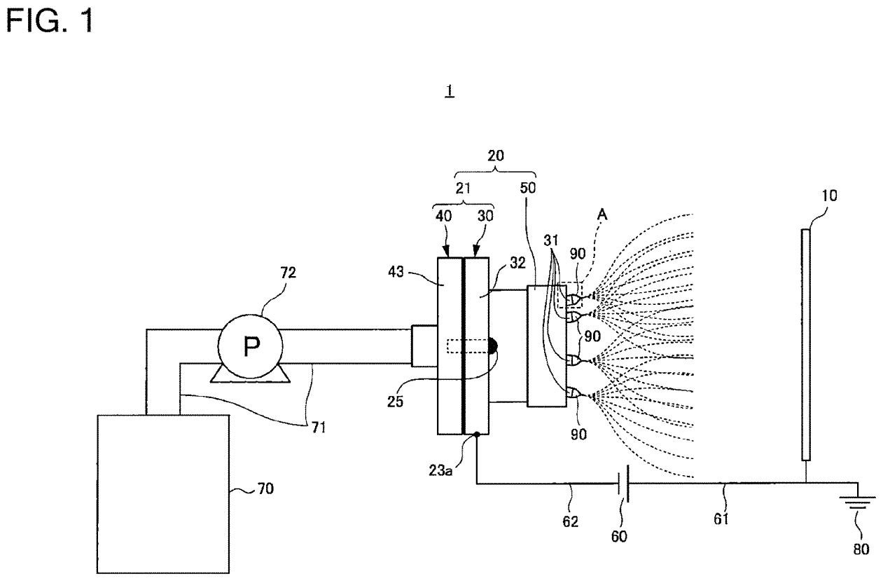

FIG. 1 is a side view of an electrostatic spraying apparatus 1 of an embodiment according to the present invention.

FIG. 1 schematically illustrates that a liquid such as paint is sprayed from a nozzle 31.

As illustrated in FIG. 1, the electrostatic spraying apparatus 1 includes a liquid sprayer 20, a voltage application device 60 that applies a voltage between the liquid sprayer 20 and a to-be-coated object (an object to be coated) 10, a pump 72 that supplies a liquid such as paint in a liquid storage tank 70 to the liquid sprayer 20 through a liquid supply pipe 71, and a grounding device 80 connected to first electric wiring 61 connected to the to-be-coated object 10 from the voltage application device 60.

In addition, the liquid sprayer 20 includes a head 21 having a nozzle group including of a plurality of nozzles 31 and an external electrode 50 disposed outside the nozzle group.

In the present embodiment, the to-be-coated object 10 is grounded by the grounding device 80. However, the grounding device 80 is not an essential requirement.

However, since the to-be-coated object 10 may be touched by an operator, it is preferable to provide the grounding device 80 to ground the to-be-coated object 10 from a viewpoint of safety.

(Pump)

The pump 72 is a supply apparatus for supplying the liquid in the liquid storage tank 70 to the head 21 through the liquid supply pipe 71 at a predetermined supply pressure.

Then, the liquid supplied by the pump 72 is supplied to each nozzle 31 through a flow path in the head 21.

(Voltage Application Device)

The voltage application device 60 is a voltage power supply for applying a voltage between the to-be-coated object 10 and the liquid sprayer 20.

As will be described below, more specifically, the voltage application device 60 applies a voltage between the to-be-coated object 10, and the plurality of nozzles 31 and the external electrode 50.

Then, when a voltage is applied between the to-be-coated object 10 and the liquid sprayer 20 by the voltage application device 60, an electrostatic force is generated between the to-be-coated object 10 and the liquid sprayer 20.

The liquid supplied to each nozzle 31 is charged by this electrostatic force, and the liquid is released from the nozzle 31 and sprayed by the electrostatic force.

Specifically, an electrostatic force pulling the liquid forward is balanced with an adhesion force to a distal end outer peripheral edge of the nozzle 31 due to surface tension and/or viscosity, which cause the liquid supplied to a side of a distal end of the nozzle 31 to have a conical shape at the distal end, so that a tailor cone 90 is formed.

The tailor cone 90 is formed when positive/negative charge separation occurs in the liquid by an action of an electric field, and a meniscus at the distal end of the nozzle 31 charged with excess charge is deformed to have a conical shape.

Then, the liquid is further pulled from the distal end of the tailor cone 90 by electrostatic force. Thereafter, the liquid is sprayed by electrostatic explosion.

The sprayed liquid, that is, the liquid released from the nozzle 31 to become liquid particles has a dramatically larger area exposed to air when compared to a state before release, so that evaporation of a solvent is promoted, a distance between changed electrons decreases due to evaporation of the solvent, and electrostatic repulsion (electrostatic explosion) occurs to further divide the liquid particles into liquid particles having smaller particle sizes.

When this division occurs, a surface area exposed to air further increases compared to that before division, so that evaporation of the solvent is promoted, electrostatic explosion occurs as described above, and the liquid particles are further divided into liquid particles having smaller particle sizes.

The liquid is atomized by repeating such electrostatic explosion.

Then, the liquid sprayed in such a manner is charged, and thus is attracted to the to-be-coated object 10 by electrostatic force and applied to the to-be-coated object 10 with high efficiency.

(Liquid Sprayer)

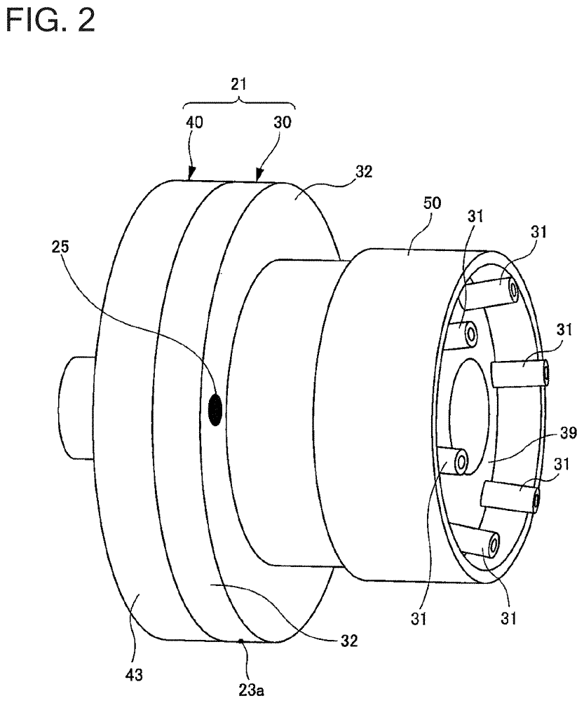

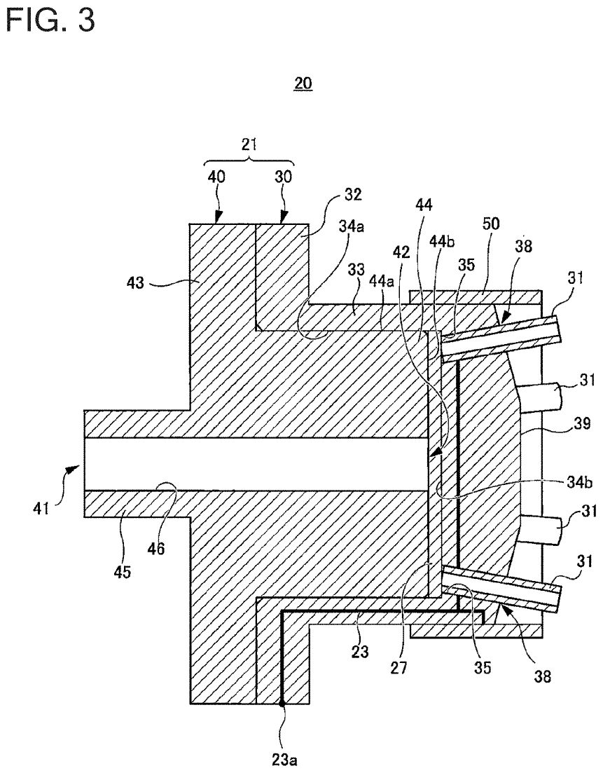

FIG. 2 is a perspective view of the liquid sprayer 20, and FIG. 3 is a cross-sectional view passing through a center of the liquid sprayer 20.

As illustrated in FIG. 3, the liquid sprayer 20 includes the head 21 and the external electrode 50.

Further, the head 21 includes a first head 40 having an outflow portion 42 from which the liquid supplied to a supply portion 41 by a pump 72 (see FIG. 1) flows out, and a second head 30 attached to the first head 40 to cover the outflow portion 42 and provided with the plurality of nozzles 31.

In addition, the second head 30 includes a first opening 35 serving as a port for supplying a liquid to the nozzle 31 and a plurality of second openings 38 which communicates with the first opening 35 and corresponds to the plurality of nozzles 31 and into which the nozzles 31 are inserted such that a liquid flowing out from the outflow portion 42 of the first head 40 is supplied to the nozzles 31.

The plurality of second openings 38 is provided on an outer surface 39 on a front side of the second head 30 located opposite to the first head 40, and the plurality of second openings 38 is disposed to be concentrically located as can be seen from an arrangement state of the nozzles 31 of FIG. 2.

Furthermore, in the present embodiment, the first head 40 and the second head 30 are formed of an insulating material, and the plurality of nozzles 31 is formed of a conductive material or a material having surface resistance of 10¹⁰Ω or less.

Further, as illustrated in FIG. 3, the second head 30 has connection electric wiring 23 formed of a conductive material embedded in the inside of the second head 30, and the plurality of nozzles 31 and the external electrode 50 are electrically connected by the connection electric wiring 23.

An end portion 23a of the connection electric wiring 23 is exposed from a side surface of a flange portion 32 of the second head 30, and the end portion 23a is connected, as illustrated in FIG. 1, to another second electric wiring 62 corresponding to different electric wiring from the first electric wiring 61 connected from the voltage application device 60 to the to-be-coated object 10.

Therefore, the voltage application device 60 not only applies a voltage to the nozzle 31, but also applies the same voltage as the voltage applied to the nozzle 31 to the external electrode 50.

However, the voltage application device 60 may not correspond to one voltage application device as in the present embodiment, and the voltage application device 60 may include two voltage application devices corresponding to a voltage application device for the nozzle 31 and a voltage application device for the external electrode 50. The voltage applied to the external electrode 50 may be substantially or approximately equal to the voltage applied to the nozzle 31.

Incidentally, to favorably release the liquid from the nozzle 31 and spray the liquid, it is preferable that the electrostatic force applied to the liquid is weak in the vicinity of the nozzle 31, the liquid is drawn forward so as not to cause electrostatic explosion, the liquid extends forward so as to be tapered, and a strong electrostatic force acts on a tapered portion in which a charged state is stable to cause electrostatic explosion.

That is, it is preferable to make the electrostatic force applied to the liquid intensify as a distance from the nozzle 31 increases.

Therefore, in the present embodiment, the plurality of nozzles 31 is disposed to be inclined such that distal end portions of the nozzles 31 are located on a concentric circle whose diameter is larger than a diameter of a concentric circle on which the second openings 38 are disposed.

In other words, the plurality of nozzles 31 is disposed such that the distal ends of the nozzles 31 are located on a first concentric circle in a front view in which the plurality of nozzles 31 is viewed from the front side in front, roots of the nozzles 31 located on the head 21 (second head 30) side are located on a second concentric circle whose center corresponds to a first center which is a center of the first concentric circle, and the second concentric circle has a smaller diameter than that of the first concentric circle.

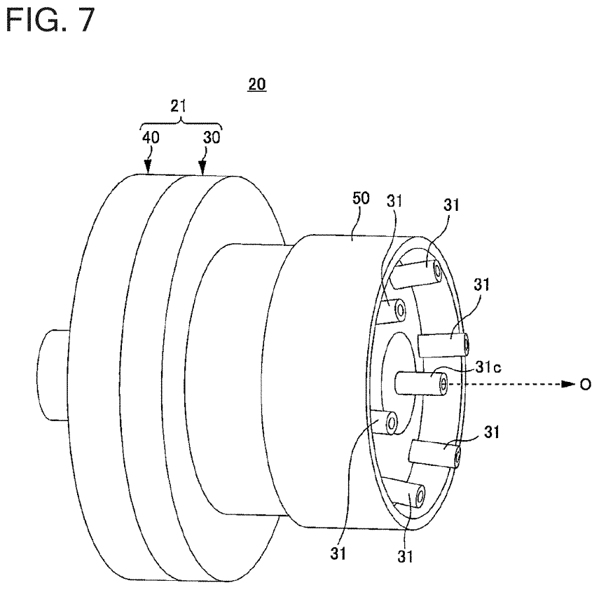

Positions of the distal end and the root of the nozzle 31 in a front-back direction are different from each other. Thus, in an accurate expression considering this difference in position, in the nozzles 31, the roots of the nozzles 31 located on the head 21 (second head 30) side are located on the second concentric circle on the back side of the first concentric circle, the center of which second concentric circle is located on a first central axis (see an O-axis of FIG. 7) that is perpendicular to the first concentric circle and passes through the first center of the first concentric circle, and the second concentric circle has a diameter equal to or smaller than that of the first concentric circle.

Further, more specifically, the second concentric circle is parallel to the first concentric circle.

Further, when a distance between liquids (hereinafter a portion of a liquid from the distal end of the nozzle 31 to electrostatic explosion is referred to as a liquid line) extending from the nozzles 31 is short, electrostatic forces applied to the individual liquid lines become weak. However, when the nozzles 31 are inclined as described above, the liquid lines extending from the respective nozzles 31 are separated from other as approaching the front side, the electrostatic force can strongly act on each liquid line, and it is possible to realize a preferable state in which the electrostatic force applied to the liquid becomes stronger as being separated from the nozzle 31.

Next, a description will be given of more specific configurations of the first head 40 and the second head 30.

As illustrated in FIG. 3, the first head 40 has a flange portion 43 provided at a position on the back side and a first protrusion 44 located on a central side of the flange portion 43 and protruding forward from the flange portion 43, the first protrusion 44 having a cylindrical external shape and accommodated in the second head 30.

In addition, the first head 40 has a second protrusion 45 which is provided at the central side of the flange portion 43 and protrudes backward from the flange portion 43 and in which the supply portion 41 is formed. Here, the liquid supply pipe 71 (see FIG. 1) supplying the liquid is connected to the supply portion 41.

Further, a through-hole 46 penetrating a center of the first head 40 is formed in the first head 40 so that the supply portion 41 and the outflow portion 42 communicate with each other by the through-hole 46.

Meanwhile, the second head 30 has the flange portion 32 corresponding to the flange portion 43 of the first head 40 which is provided at a position on the back side and in which an opening having an inner diameter substantially equal to an outer diameter of the first protrusion 44 of the first head 40 is formed at a center, and a covering portion 33 protruding forward from the flange portion 32 and having a recess which is open to an opening side of the flange portion 32 and substantially equal to the outer diameter of the first protrusion 44 of the first head 40.

Further, as illustrated in FIG. 1, the first head 40 and the second head 30 form the head 21 when the flange portion 32 of the second head 30 and the flange portion 43 of the first head 40 are tightened together by a screw 25 to integrate the first head 40 and the second head 30.

In addition, as illustrated in FIG. 3, an outer peripheral surface 44a of the first protrusion 44 of the first head 40 comes into contact with an inner peripheral surface 34a of the flange portion 32 and the covering portion 33 of the second head 30 corresponding to the outer peripheral surface 44a of the first protrusion 44 so that the liquid does not leak from between the first head 40 and the second head 30.

Meanwhile, a first surface 44b corresponding to a front side end surface of the first protrusion 44 of the first head 40 on which the outflow portion 42 is formed is separated from a second surface 34b of the second head 30 facing the outflow portion 42 of the first head 40 to form a flow path from the outflow portion 42 to the plurality of nozzles 31 through which the liquid flows.

Further, a resistance member 27 for generating flow path resistance is provided in the flow path formed by the first surface 44b and the second surface 34b, by which a resistance portion having flow path resistance is formed on the flow path reaching the nozzles 31 through which the liquid flows.

For example, as the resistance member 27, it is possible to use a member made of fiber such as non-woven fabric formed in the same external shape as that of a space corresponding to the flow path formed by the first surface 44b and the second surface 34b, or a member obtained by molding glass or ceramic in a shape of a porous body.

It is preferable to select the resistance member 27 to have flow path resistance of a water head pressure (water load) H (mmAq) or more between an uppermost nozzle 31 and a lowermost nozzle 31 when a central axis of the liquid sprayer 20 is horizontally disposed to spray the liquid in a horizontal direction.

When such a resistance portion is provided, and the central axis of the liquid sprayer 20 is horizontally disposed to spray the liquid in the horizontal direction, since there is the flow path resistance of the water load H (mmAq) or more due to a difference in position between the uppermost nozzle 31 and the lowermost nozzle 31, the liquid is prevented from flowing to a nozzle 31 side located on a lower side due to a weight thereof, and it is possible to supply a substantially equal amount of liquid to any nozzle 31.

In addition, in an apparatus that sprays the liquid from the nozzle 31 by the electrostatic force, it is preferable that an inner diameter of the nozzle 31 is set to, for example, about 0.2 mmϕ or more and 0.5 mmϕ or less to perform stable spraying. Even though clogging by foreign matter, etc. is likely to occur due to the small inner diameter, since the resistance member 27 serves as a filter, an effect of suppressing occurrence of clogging is exhibited.

When the flow path resistance of the resistance portion is excessively large, the liquid may not be satisfactorily supplied to each nozzle 31. Thus, it is preferable that the resistance portion has flow path resistance of 90% or less with respect to the supply pressure of the pump 72 that supplies the liquid.

Furthermore, in terms of clogging, as in the present embodiment, since the head 21 is disassembled into the first head 40 and the second head 30 and cleaning of the nozzle 31 is facilitated, even when the liquid is fixed in the nozzle 31 and clogging occurs, the clogging can be easily eliminated.

Further, the liquid sprayer 20 includes the external electrode 50 screwed to an outer periphery of the second head 30 such that a position in the front-back direction can be adjusted.

Specifically, the external electrode 50 is a cylindrical member formed of a conductive material or a material having surface resistance of 10¹⁰Ω or less and having a screwing groove formed on an inner peripheral surface of the cylindrical member, and is attached to the second head 30 by screwing into a screwing groove provided on an outer periphery of the second head 30.

Therefore, by changing a screwing amount of the external electrode 50 with respect to the second head 30, the external electrode 50 can be moved in the front-back direction, and a position in the front-back direction can be adjusted.

The external electrode 50 is provided to surround a nozzle group including the plurality of nozzles 31.

Specifically, the external electrode 50 is provided to surround the nozzle group in a circle whose center corresponds to the first center which is the center of the first concentric circle on which the distal end of the nozzle 31 is located in the front view in which the plurality of nozzles 31 is viewed from the front side in front.

In an accurate expression considering a positional relationship in the front-back direction, the external electrode 50 is provided to surround the nozzle group in a circle whose center is on the first central axis (see the O-axis of FIG. 7), which first central axis is perpendicular to the first concentric circle and passes through the first center of the first concentric circle.

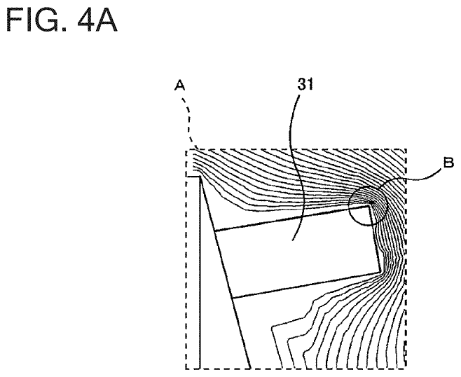

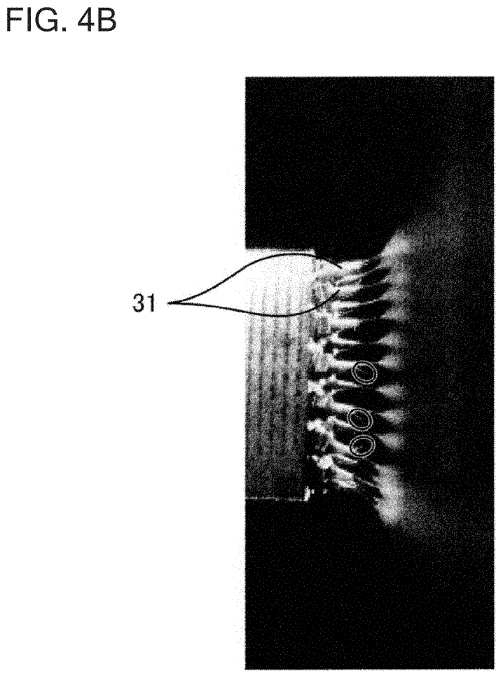

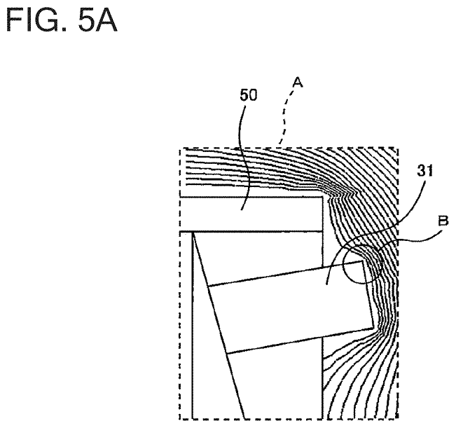

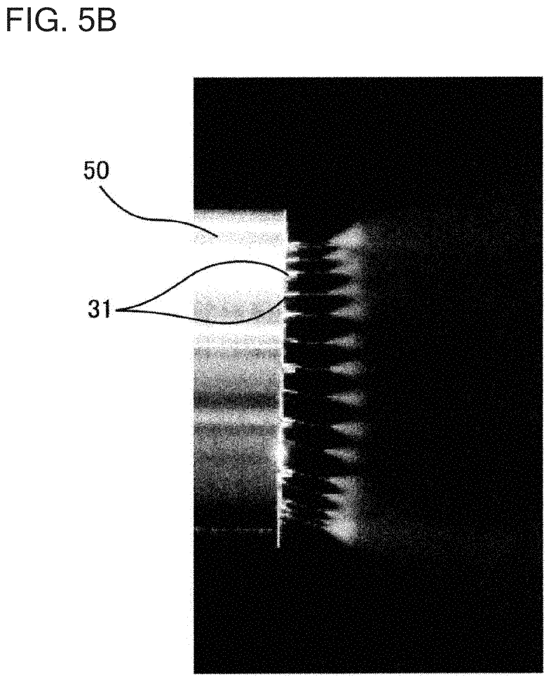

Next, a more detailed description including a function of the external electrode 50 will be given with reference to FIGS. 4A and 4B and FIGS. 5A and 5B.

FIGS. 4A and 4B are views illustrating a state in which the external electrode 50 is removed, FIG. 4A is an enlarged view of a portion corresponding to a dotted frame portion A of FIG. 1, and FIG. 4B is a photograph showing that the liquid is being sprayed.

In addition, FIGS. 5A and 5B are views illustrating the state in which the external electrode 50 is attached, FIG. 5A is an enlarged view of the portion corresponding to the dotted frame portion A of FIG. 1, and FIG. 5B is a photograph showing that the liquid is being sprayed.

FIG. 4A and FIG. 5A also illustrate equipotential curves that appear when a voltage is applied.

As can be seen from FIG. 4B, even in the state in which the external electrode 50 is removed, the liquid line extends from the distal end of the nozzle 31, electrostatic explosion occurs at a distal end of the liquid line, and the liquid spray can be sprayed.

However, focusing on a circled part, a whisker-like separated liquid is occasionally found near the distal end of the nozzle 31.

As described above, the whisker-like separated liquid in the vicinity of the distal end of the nozzle 31, not at the distal end of the liquid line, has an unstable charged state. Thus, a state of repeated electrostatic explosion after separation is different from that of liquid particles released from the distal end of the liquid line by electrostatic explosion, which may cause uneven coating.

Therefore, as a result of investigating this cause, as illustrated in FIG. 4A, a state in which an electric field is concentrated on an outer edge (refer a circled part B) of the distal end of the nozzle 31 was found to arise.

It is presumed that when a part on which the electric field is concentrated (hereinafter also referred to as an electric field concentration part) is present as described above, the liquid line at a position near the electric field concentration part is strongly charged, electrostatic explosion partially occurs, and thus the whisker-like separated liquid is generated as seen in FIG. 4B.

The whisker-like separated liquid may not be generated from a position corresponding to an outer side of the nozzle 31, which merely means that a direction in which the whisker separates is not determined due to an influence of a secondary effect of partial electrostatic explosion, etc. It is presumed that an essential cause lies in this electric field concentration part.

On the other hand, when the external electrode 50 is provided as illustrated in FIG. 5A, the electric field concentration part seen in FIG. 4A may not be seen (see the circled part B of FIG. 4A and FIG. 5A).

Further, as can be seen from FIG. 5B, no whisker-like separated liquid is observed near the distal end of the nozzle 31, and only the liquid is sprayed by electrostatic explosion at the distal end of the liquid line extending from the distal end of the nozzle 31.

It is unclear whether the whisker-like separated liquid is completely absent when the external electrode 50 is provided. However, the whisker-like separated liquid is not found as far as observed, and it is considered that an occurrence probability of the whisker-like separated liquid can be greatly reduced.

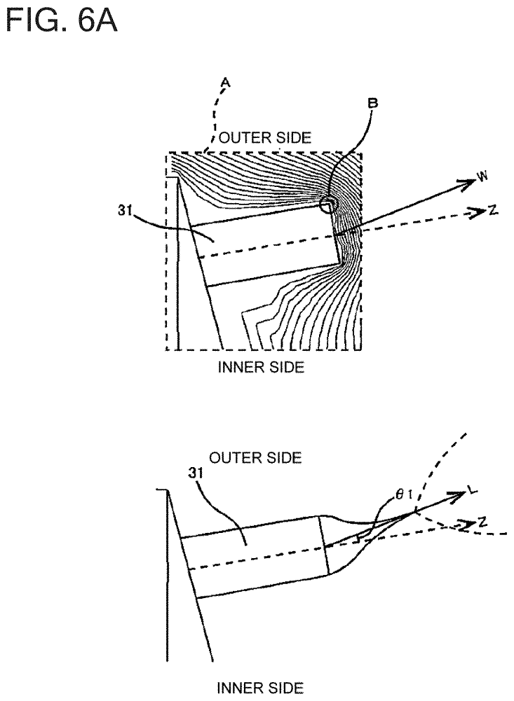

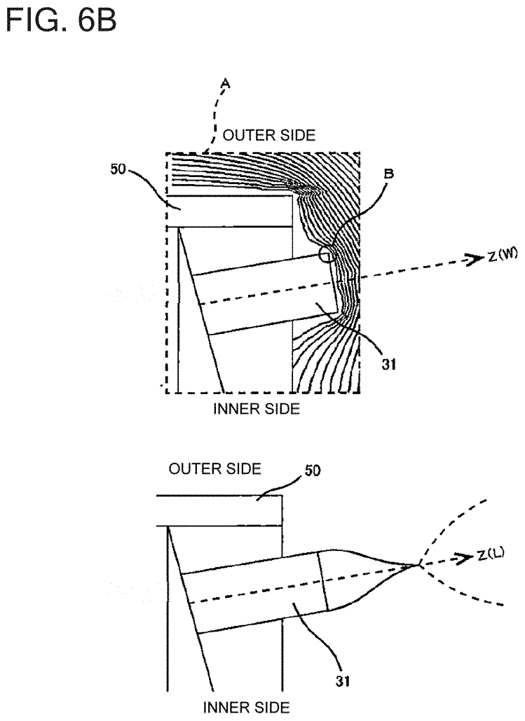

Naturally, when the external electrode 50 is positioned on the far back side of the nozzle 31, it is presumed that the above effect may not be obtained. However, in a process of performing the above improvement, a rough guide can be obtained with regard to excellent arrangement of the external electrode 50. This point will be described below with reference to FIGS. 6A and 6B.

FIGS. 6A and 6B are views for description with respect to arrangement of the external electrode 50, FIG. 6A is a view illustrating a state in which the external electrode 50 is not provided, and FIG. 6B is a view illustrating a state in which the external electrode 50 is provided.

An upper drawing of FIG. 6A is a view corresponding to FIG. 4A, and an upper drawing of FIG. 6B is a view corresponding to FIG. 5A.

In addition, a Z-axis of FIG. 6A and FIG. 6B indicates the central axis of the nozzle 31.

A pull direction by the electrostatic force is applied in a direction orthogonal to the equipotential curve. Thus, when the external electrode 50 is not provided as in the upper drawing of FIG. 6A, the pull direction is inclined to the outer side of the central axis (see the Z-axis) of the nozzle 31 as can be seen from a W-axis indicating the pull direction by being affected by the electric field concentration part (see the circled part B).

For this reason, as illustrated in a lower drawing of FIG. 6A, a direction (see an L-axis) of the liquid line extending forward from the nozzle 31 is inclined to the outer side by an angle θ1 with respect to the central axis (see the Z-axis) of the nozzle 31.

On the other hand, as illustrated in FIG. 6B, when the external electrode 50 is provided, and concentration of the electric field on the outer end (see the circled part B) of the nozzle 31 is mitigated as illustrated in the upper drawing of FIG. 6B, distortion of the equipotential curve appearing on the distal end side of the nozzle 31 is eliminated, and the equipotential curve appearing in front of the nozzle 31 almost becomes parallel to a distal end surface of the nozzle 31.

For this reason, the W-axis indicating the pull direction is not inclined much with respect to the central axis (see the Z-axis) of the nozzle 31 as illustrated in the upper drawing of FIG. 6B, the direction (see the L-axis) of the liquid line extending forward from the nozzle 31 is not inclined much with respect to the central axis (see the Z-axis) of the nozzle 31 as illustrated in the lower drawing of FIG. 6B, and an inclination of the liquid line extending forward from the nozzle 31 with respect to the central axis (see the Z-axis) of the nozzle 31 is reduced as can be seen from the lower drawing of FIG. 6B.

For ease of understanding, FIG. 6B illustrates a case in which the central axis (see the Z-axis) of the nozzle 31 coincides with the direction (see the L-axis) of the liquid line extending forward from the nozzle 31 and the pull direction (see the W-axis). However, the directions do not necessarily coincide with the central axis.

That is, it suffices that the liquid line extending forward from the nozzle 31 is not largely inclined to the outer side or the inner side with respect to the central axis (see the Z-axis) of the nozzle 31 such that there is no electric field concentration part having an issue or a problem.

Specifically, it is favorable to move the external electrode 50 in the front-back direction and dispose the external electrode 50 such that the external electrode 50 is located at a position at which an inclination of the liquid line extending forward from the nozzle 31 to the outer side or the inner side with respect to the central axis (see the Z-axis) of the nozzle 31 is within 10 degrees. More preferably, the external electrode 50 is disposed such that the external electrode 50 is located at a position at which the inclination of the liquid line with respect to the central axis is within 5 degrees.

Incidentally, when a voltage applied to the external electrode 50 is largely different from a voltage applied to the nozzle 31, there is concern that a potential difference between the external electrode 50 and the nozzle 31 may distort an equipotential curve state. Thus, it is preferable to apply the same voltage as that applied to the nozzle 31 to the external electrode 50.

The same voltage mentioned here does not mean completely the same voltage and means the same voltage to the extent that the equipotential curve state is not largely distorted due to the potential difference between the external electrode 50 and the nozzle 31.

For example, the extent corresponds to within ±10%, more preferably within ±5% of a voltage applied between the to-be-coated object 10 and the nozzle 31. When the nozzle 31 and the external electrode 50 are connected to the second electric wiring 62 of the voltage application device 60 as in this embodiment, a simple configuration is obtained, and a voltage considered to be substantially the same can be applied, which is most preferable.

Even though the electrostatic spraying apparatus 1 of the present invention has been described above based on the specific embodiment, the present invention is not limited to the specific embodiment.

In a case in which the nozzle group including the plurality of nozzles 31 is provided in the annular shape such that the distal end of the nozzle 31 is disposed in a shape of the first concentric circle whose center corresponds to the first center on an axial line (see the O-axis of FIG. 7) extending toward from the center of the head 21 (the second head 30) as in the embodiment, the field concentration part does not appear on the inner side (first center side) of the distal end of the nozzle 31.

It is presumed that the inner side of the nozzle group is in a state in which the electric field concentration part is rarely generated by an action of each nozzle 31. However, when the diameter of the first concentric circle increases, an action between the respective nozzles 31 is less likely to occur. Thus, it is considered that the electric field concentration part may be generated even on the inner side (first center side) of the distal end of the nozzle 31.

Therefore, as in a modification of the head 21 illustrated in FIG. 7, it is possible to include an inner nozzle 31C provided on the inner side of the nozzle group whose distal end is located on the first concentric circle.

In this case, it is considered to be preferable to provide the inner nozzle 31C is provided on the first central axis (see the O-axis of FIG. 7) which is perpendicular to the first concentric circle and passes through the first center of the first concentric circle to prevent the inner nozzle 31C from unevenly affecting the nozzle 31.

That is, it is preferable that the inner nozzle 31C is provided at the center of the head 21.

According to the embodiment, it is possible to provide an electrostatic spraying apparatus and an electrostatic spraying method for improving stability of a spray condition of a liquid such as paint, in an electrostatic spraying apparatus having a plurality of nozzles for spraying a liquid such as paint to an object to be coated.

At least the following modes are comprehended from the embodiment.

(1) An electrostatic spraying apparatus according to a mode is an electrostatic spraying apparatus that releases a liquid from a nozzle of a liquid sprayer in a charged state by an electrostatic force generated by application of a voltage and sprays the liquid to an object to be coated, in which the liquid sprayer includes a head having a nozzle group that includes a plurality of nozzles, and an external electrode disposed on an outer side of the nozzle group, the same voltage as a voltage applied to the nozzles being applied to the external electrode.

(2) In a configuration of item (1), the external electrode is provided to surround the nozzle group.

(3) In a configuration of item (2), the plurality of nozzles is disposed such that distal ends of the nozzles are located on a first concentric circle, and the external electrode is provided to surround the nozzle group in a circle whose center is on a first central axis passing through a first center of the first concentric circle and perpendicular to the first concentric circle.

(4) In a configuration of item (3), roots of the nozzles located on a side of the head are located on a second concentric circle whose center is located on the first central axis, and the second concentric circle has a diameter less than or equal to a diameter of the first concentric circle.

(5) In a configuration of item (3) or (4), the head further has an inner nozzle provided on an inner side of the nozzle group whose distal end is located on the first concentric circle.

(6) In a configuration of item (5), the inner nozzle is provided to be located on the first central axis.

(7) In a configuration of any one of items (1) to (6), the external electrode is provided at a position at which an inclination of a liquid line extending forward from the nozzle with respect to a central axis of the nozzle is within 10 degrees, more preferably within 5 degrees.

(8) In a configuration of any one of items (1) to (7), the head includes a first head having an outflow portion from which the liquid flows out, a second head provided with the plurality of nozzles and attached to the first head to cover the outflow portion, and a resistance portion having flow path resistance, the resistance portion being provided on a flow path from the outflow portion to the plurality of nozzles through which the liquid flows, the external electrode has a cylindrical shape, and the external electrode is screwed to an outer periphery of the second head such that a position in a front-back direction of the external electrode is allowed to be adjusted.

(9) In a configuration of item (8), the resistance member includes a porous member formed in the same external shape as that of a space corresponding to the flow path.

(10) In a configuration of item (8) or (9), when a central axis of the liquid sprayer is horizontally disposed to spray the liquid in a horizontal direction, the resistance member has flow path resistance corresponding to a water load between an uppermost nozzle and a lowermost nozzle or more.

(11) In a configuration of any one of items (8) to (10), the resistance member has flow path resistance of 90% or less with respect to a supply pressure of a pump that supplies the liquid.

(12) In a configuration of item (4), the second concentric circle is parallel to the first concentric circle.

(13) In a configuration of any one of items (1) to (12), the electrostatic spraying apparatus includes a voltage application device that applies voltages to the nozzle and the external electrode, in which the voltage application device applies the same voltage as a voltage applied to the nozzle to the external electrode.

(14) An electrostatic spraying method of the present invention is an electrostatic spraying method of releasing a liquid from a nozzle of a liquid sprayer in a charged state by an electrostatic force generated by application of a voltage and spraying the liquid to an object to be coated, the electrostatic spraying method including disposing an external electrode on an outer side of a nozzle group including a plurality of nozzles to apply the same voltage as a voltage applied to the nozzle to the external electrode.

(15) In a configuration of item (14), the plurality of nozzles is disposed such that distal ends of the nozzles are located on a first concentric circle, and the external electrode is provided to surround the nozzle group in a circle whose center is on a first central axis passing through a first center of the first concentric circle and perpendicular to the first concentric circle.

(16) In a configuration of item (14) or (15), the external electrode is provided at a position at which an inclination of a liquid line extending forward from the nozzle with respect to a central axis of the nozzle is within 10 degrees, more preferably within 5 degrees.

As described above, the present invention is not limited to the above embodiment, and those appropriately modified or improved are also included in the technical scope of the present invention, which is apparent to those skilled in the art from the description of the claims. Even though the embodiment of the present invention has been described above based on several examples, the above-described embodiment of the invention is for the purpose of facilitating the understanding of the present invention, and is not intended to limit the present invention. The present invention can be modified and improved without departing from a subject matter thereof, and the present invention naturally includes equivalents thereof. In addition, any combination or omission of respective components described in the claims and the specification is allowed within a range in which at least a part of the above-mentioned problems can be solved, or a range that exerts at least a part of the effect.

This application claims the priority based on Japanese Patent Application No. 2016-229861 filed on Nov. 28, 2016. The entire disclosure of Japanese Patent Application No. 2016-229861 filed on Nov. 28, 2016, including the specification, claims, drawings, and abstract is incorporated herein by reference.

The entire disclosure of JP 2008-516766 A (Patent Literature 1) including the specification, claims, drawings, and abstract is incorporated herein by reference.

### REFERENCE SIGNS LIST

1 ELECTROSTATIC SPRAYING APPARATUS

10 OBJECT TO BE COATED

20 LIQUID SPRAYER

21 HEAD

23 CONNECTION ELECTRIC WIRING

25 SCREW

27 RESISTANCE MEMBER

30 SECOND HEAD

31 NOZZLE

32 FLANGE PORTION

33 COVERING PORTION

34a INNER PERIPHERAL SURFACE

34b SECOND SURFACE

35 FIRST OPENING

38 SECOND OPENING

39 OUTER SURFACE

40 FIRST HEAD

41 SUPPLY PORTION

42 OUTFLOW PORTION

43 FLANGE PORTION

44 FIRST PROTRUSION

44a OUTER PERIPHERAL SURFACE

44b FIRST SURFACE

45 SECOND PROTRUSION

46 THROUGH-HOLE

50 EXTERNAL ELECTRODE

60 VOLTAGE APPLICATION DEVICE

61 FIRST ELECTRIC WIRING

62 SECOND ELECTRIC WIRING

70 LIQUID STORAGE TANK

71 LIQUID SUPPLY PIPE

72 PUMP

80 GROUNDING DEVICE

90 TAILOR CONE

H WATER LOAD

O FIRST CENTRAL AXIS

1. An electrostatic spraying apparatus that releases a liquid from a nozzle of a liquid sprayer in a charged state by an electrostatic force generated by application of a voltage and sprays the liquid to an object to be coated, wherein
the liquid sprayer includes
a head having a nozzle group that includes a plurality of nozzles, and
an external electrode disposed on an outer side of the nozzle group, the same voltage as a voltage applied to the nozzles being applied to the external electrode.

2. The electrostatic spraying apparatus according to claim 1, wherein the external electrode is provided to surround the nozzle group.

3. The electrostatic spraying apparatus according to claim 2, wherein
the plurality of nozzles is disposed such that distal ends of the nozzles are located on a first concentric circle, and
the external electrode is provided to surround the nozzle group in a circle whose center is on a first central axis passing through a first center of the first concentric circle and perpendicular to the first concentric circle.

4. The electrostatic spraying apparatus according to claim 3, wherein roots of the nozzles located on a side of the head are located on a second concentric circle whose center is located on the first central axis, and the second concentric circle has a diameter less than or equal to a diameter of the first concentric circle.

5. The electrostatic spraying apparatus according to claim 3, wherein the head further has an inner nozzle provided on an inner side of the nozzle group whose distal end is located on the first concentric circle.

6. The electrostatic spraying apparatus according to claim 5, wherein the inner nozzle is provided to be located on the first central axis.

7. The electrostatic spraying apparatus according to claim 1, wherein the external electrode is provided at a position at which an inclination of a liquid line extending forward from the nozzle with respect to a central axis of the nozzle is within 10 degrees.

8. The electrostatic spraying apparatus according to claim 1, wherein
the head includes
a first head having an outflow portion from which the liquid flows out,
a second head provided with the plurality of nozzles and attached to the first head to cover the outflow portion, and
a resistance portion having flow path resistance, the resistance portion being provided on a flow path from the outflow portion to the plurality of nozzles through which the liquid flows,
the external electrode has a cylindrical shape, and
the external electrode is screwed to an outer periphery of the second head such that a position in a front-back direction of the external electrode is allowed to be adjusted.

9. The electrostatic spraying apparatus according to claim 4, wherein the second concentric circle is parallel to the first concentric circle.

10. The electrostatic spraying apparatus according to claim 1, comprising
a voltage application device that applies voltages to the nozzle and the external electrode, wherein
the voltage application device applies the same voltage as a voltage applied to the nozzle to the external electrode.

11. An electrostatic spraying method of releasing a liquid from a nozzle of a liquid sprayer in a charged state by an electrostatic force generated by application of a voltage and spraying the liquid to an object to be coated, the electrostatic spraying method comprising
disposing an external electrode on an outer side of a nozzle group including a plurality of nozzles to apply the same voltage as a voltage applied to the nozzle to the external electrode.

12. The electrostatic spraying method according to claim 11, wherein
the plurality of nozzles is disposed such that distal ends of the nozzles are located on a first concentric circle, and
the external electrode is provided to surround the nozzle group in a circle whose center is on a first central axis passing through a first center of the first concentric circle and perpendicular to the first concentric circle.

13. The electrostatic spraying method according to claim 11, wherein the external electrode is provided at a position at which an inclination of a liquid line extending forward from the nozzle with respect to a central axis of the nozzle is within 5 degrees.
